(19) United States
(12) Patent Application Publication
(10) Pub. No.: US 2025/0225385 A1
(43) Pub. Date: Jul. 10, 2025

(54) PERFORMING A DATA PROCESSING TASK ON A DATA SET USING PRETRAINED LANGUAGE MODELS

(71) Applicant: International Business Machines Corporation, Armonk, NY (US)

(72) Inventors: Takayuki Osogami, Yamato-shi (JP); KOHEI MIYAGUCHI, Tokyo (JP); RYO IWAKI, Sumida-ku (JP)

(21) Appl. No.: 18/405,025

(22) Filed: Jan. 5, 2024

(51) Int. Cl. G06N 3/08

(52) U.S. Cl. CPC G06N 3/08

(57) ABSTRACT

Computer-implemented methods for performing a data processing task on a data set with a pretrained language model are provided. Aspects include obtaining the data set and a type of the data processing task to be performed on the data set, generating a prompt by inputting data from the data set into a template, and inputting the prompt into an encoder of a pretrained language model. Aspects also include obtaining, from the encoder, a set of prompt embeddings and a set of token embeddings, inputting the set of prompt embeddings into a trained neural network, and obtaining, from the trained neural network, a prefix vector. Aspects further include inputting a set of extended embeddings that are created by appending the set of token embeddings to the prefix vector into a decoder of the pretrained language model, obtaining, from the decoder, an output, and modifying the data set based on the output.

### BACKGROUND

The present disclosure generally relates to performing data processing tasks, and more specifically, to performing data processing tasks on a data set using a pretrained language model.

Data processing tasks, also referred to as data wrangling tasks, (e.g., entity matching, data imputation, error detection/correction, etc.) are time-consuming tasks that are often performed by data scientists to clean up a raw data set and to prepare the data set for additional processing and analytics. In general, such data processing tasks are manual in nature and consume up to eighty percent of the time spent by data scientists preparing data sets for additional processing and analytics.

### SUMMARY

Embodiments of the present disclosure are directed to computer-implemented methods for performing a data processing task on a data set with a pretrained language model. The computer-implemented method includes obtaining the data set and a type of the data processing task to be performed on the data set, generating a prompt by inputting data from the data set into a template, and inputting the prompt into an encoder of a pretrained language model. The method also includes obtaining, from the encoder, a set of prompt embeddings and a set of token embeddings, inputting the set of prompt embeddings into a trained neural network, and obtaining, from the trained neural network, a prefix vector. The method further includes inputting a set of extended embeddings that are created by appending the set of token embeddings to the prefix vector into a decoder of the pretrained language model, obtaining, from the decoder, an output, and modifying the data set based on the output.

Embodiments also include computing systems and computer program products for storing data with replicated metadata in a scale-out data storage system.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 is a block diagram of an example computer system for use in conjunction with one or more embodiments of the present disclosure;

FIG. 2 is a block diagram of a processing system for performing a data processing task on a data set with a pretrained language model in accordance with one or more embodiments of the present disclosure;

FIG. 3 is a flowchart of a method for training a neural network for prefix generation in accordance with one or more embodiments of the present disclosure;

FIG. 4 is a flowchart of a method for performing a data processing task on a data set with a pretrained language model with one or more embodiments of the present disclosure;

FIG. 5 is a flowchart of a method for performing a data processing task on a data set with a pretrained language model in accordance with one or more embodiments of the present disclosure; and

FIG. 6 is a flowchart of a method for performing a data processing task on a data set with a pretrained language model in accordance with one or more embodiments of the present disclosure.

### DETAILED DESCRIPTION

As discussed in more detail above, data processing tasks are time-consuming tasks performed by data scientists to clean up a raw data set for additional processing and analytics. Recently, pretrained large language models (PLMs), such as GPT-3.5 and GPT-4.0, have been used to perform such data processing tasks. However, using such PLMs to perform the data processing tasks relies on carefully crafted prompts and very large models. One method of eliminating the need for carefully crafting prompts and/or the use of very large PLMs is prefix tuning. Unfortunately, to effectively utilize prefix tuning, substantial training data is required for each domain, or type of data source.

In exemplary embodiments, methods, systems, and computer program products for performing a data processing task on a data set with a pretrained language model (PLM) are provided. In exemplary embodiments, a data processing task is performed using a combination of PLM with a trained neural network. In exemplary embodiments, a plurality of trained neural networks are created that each correspond to a specific type of data processing task, such as entity matching, data imputation, error detection/correction, etc. In exemplary embodiments, information about an instance of a data processing task is formatted into a prompt that is provided to an encoder of a pretrained language model (PLM) to obtain a set of prompt encodings. The prompt encodings are then provided to one of the plurality of neural networks to produce an instance-dependent prefix vector, wherein the neural network is selected based on the type of data processing task. The generated prefix vector is then appended to a set of token embedding output from the PLM encoder, which is then provided to a PLM decoder to obtain the solution to the data processing task.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as performing a data processing task on a data set with a pretrained language model 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

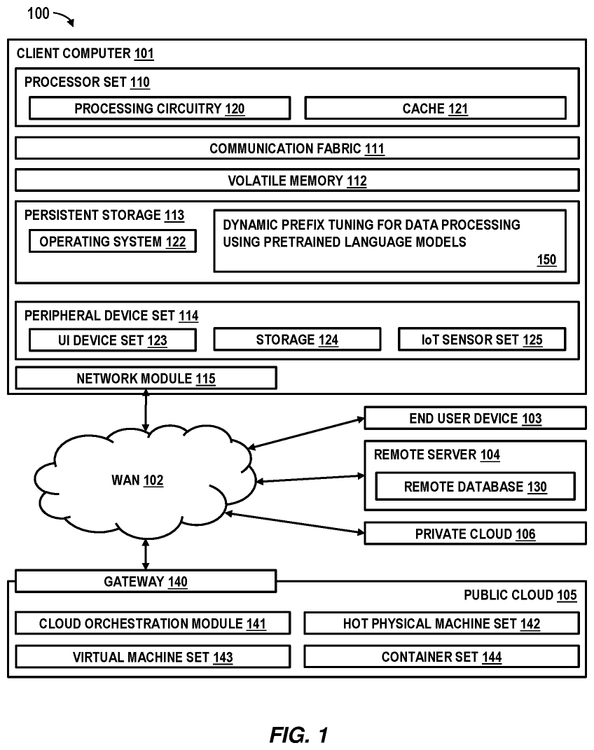

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

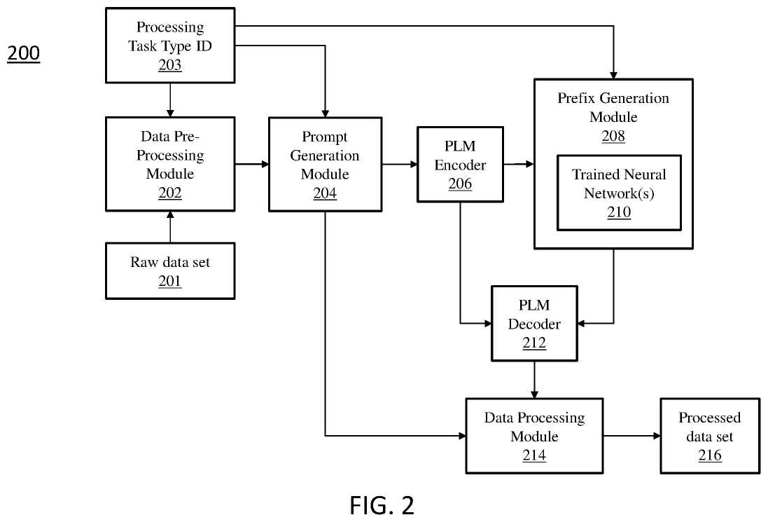

Referring now to FIG. 2, a block diagram of a system 200 for performing a data processing task on a data set with a pretrained language model in accordance with one or more embodiments of the present disclosure is shown. In exemplary embodiments, one or more elements of the system 200 may be embodied in a computing environment, such as the one shown in FIG. 1.

In exemplary embodiments, the system 200 includes a data pre-processing module 202 that is configured to receive a raw data set 201 and a processing task type identifier 203. In exemplary embodiments, the data pre-processing module 202 is configured to perform one or more known data pre-processing methods on the raw data set 202 based on the processing task type identifier 203. For example, if the processing task type identifier 203 indicates that the data processing task to be performed on the raw data set is an entity deduplication task, the data pre-processing module 202 is configured to identify and remove exact duplicates from the raw data set 201.

In exemplary embodiments, the system 200 includes a prompt generation module 204 that is configured to generate one or more prompts based on the raw data set 201 and the processing task type identifier 203. In exemplary embodiments, the prompt generation module 204 includes a plurality of prompt templates that each correspond to a specific processing task type identifier 203. The prompt generation module 204 is configured to obtain a prompt template based on the processing task type identifier 203 and to fill in one or more fields in the prompt template with data from the raw data set 201. In one example, the processing task type identifier 203 is an entity deduplication task and the template prompt is “Entity A is [Entity A data] and Entity B is [Entity B data], Are Entity A and Entity B the same Entity?” where [Entity A data] and [Entity B data] are data obtained from the raw data set 201.

In exemplary embodiments, the system 200 includes a PLM encoder 206 that is configured to receive prompts from the prompt generation module 204. In one embodiment, the PLM encoder 206 is configured to generate a set of prompt embeddings for each token in the prompt. In one embodiment, the set of prompt embeddings may be a single prompt embedding that captures the semantic meaning of the entire sequence. In another embodiment, the set of prompt embeddings captures the semantic meaning of words in the context of the entire sequence. In exemplary embodiments, the PLM encoder 206 uses self-attention mechanisms to capture relationships between different words/tokens of the prompt and encode their contextual information.

In one example, the PLM encoder 206 may be the Bidirectional Encoder Representations from Transformers (BERT) developed by Google, which is a transformer-based model that considers context from both the left and right sides of a word. In another example, the PLM encoder 206 may be the Generative Pre-trained Transformer (GPT), developed by OpenAI, which is a series of transformer-based language models. In a further example, the PLM encoder 206 may be XLNet, which is another transformer-based language model that builds upon the BERT and autoregressive models. In exemplary embodiments, the PLM encoder 206 includes a set of token embeddings that are representations of individual words (tokens) within a given text. These embeddings capture the semantic meaning of the tokens and are learned during the training of PLM encoder 206.

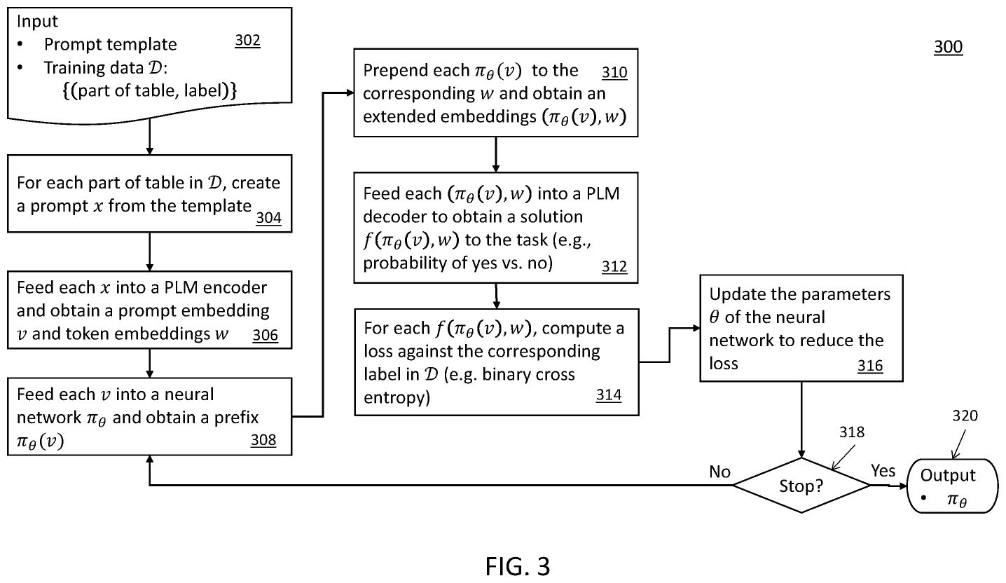

In exemplary embodiments, the system 200 includes a prefix generation module 208, which includes a plurality of trained neural network 210. In exemplary embodiments, each of the trained neural networks 210 of the prefix generation module 208 is configured to receive a set of prompt embeddings and to responsively output a prefix vector. As will be explained in more detail with regard to FIG. 3, each of the trained neural networks 210 is trained on a set of ground truth data that corresponds to a particular processing task type identifier 203. In exemplary embodiments, the prefix generation module 208 receives the processing task type identifier 203 and responsively selects one of the trained neural networks 210 to process the set of prompt embeddings. The prefix generation module 208 then creates a set of extended embeddings by appending the set of token embeddings to the prefix vector. The set of extended embeddings is provided to a PLM decoder 212.

In exemplary embodiments, the PLM decoder 212 is configured to generate an output sequence based on the contextualized representations received from the PLM encoder 206 and the prefix generation module 208. The PLM decoder 212 uses a combination of self-attention and encoder-decoder attention mechanisms and processes the output sequence token by token, generating each token based on the context of the previously generated tokens and the information encoded in the encoder's representations.

In exemplary embodiments, the system 200 includes a data processing module 214 that is configured to receive the output of the PLM decoder 212 and to responsively modify the raw data set 201 to create a processed data set 216. Continuing with the above example, where the processing task type identifier 203 is an entity deduplication task and the template prompt is “Entity A is [Entity A data] and Entity B is [Entity B data], Are Entity A and Entity B the same Entity?” Based on a determination that the output of the PLM decoder 212 indicates that Entity A and Entity B are the same entity, the data processing module 214 is configured to either delete the record for one of Entity A and Entity B from the raw data set 201 to create the processed data set 216 or to combine the data the records of Entity A and Entity B into a single record in the processed data set 216.

Referring now to FIG. 3, a flowchart of a method 300 for training a neural network for prefix generation in accordance with one or more embodiments of the present disclosure is shown. As shown at block 302, the method 300 includes receiving an input of a prompt template and a set of training data. In exemplary embodiments, the prompt template and a set of training data correspond to a specific processing task type, such as entity deduplication or entity matching, missing value imputation, error detection, and normalization. The set of training data includes ground truth data that is used to train the neural network for performing the specific processing task type.

At block 304, the method 300 includes creating prompts based on the training data sets and the prompt template. Next, as shown at block 306, the prompts are provided to a PLM encoder to obtain a set of prompt embeddings for each prompt and to obtain a set of token embeddings for the PLM encoder. The set of prompt embeddings are then input into an untrained neural network to obtain a prefix vector, as shown at block 308. Next, as shown at block 310, the prefix vector is prepended to the set of token embeddings to form a set of extended embeddings. At block 312, the extended embeddings are input into a PLM decoder, and an output is obtained. Next, at block 314, the output of the PLM decoder is compared to the ground truth data in the training data and the loss, or error rate, of the neural network is calculated. At block 316, the parameters of the neural network are updated to reduce the loss or error rate of the neural network. At decision block 318, if the loss of the neural network is less than a threshold value, the method 300 proceeds to block 320 and the trained neural network is output. Otherwise, the method 300 returns to block 308 the input data is fed back into the neural network with the updated parameters.

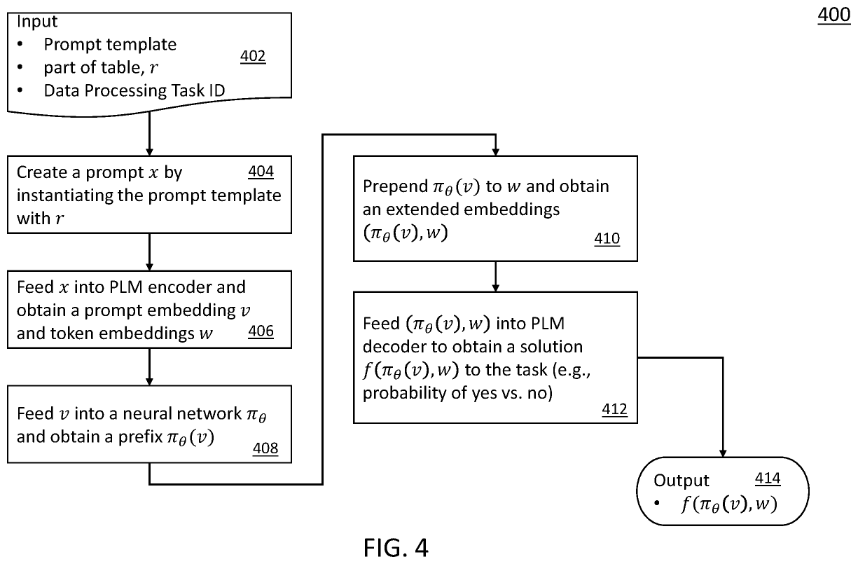

Referring now to FIG. 4, a flowchart of a method 400 for performing a data processing task on a data set with a pretrained language model with one or more embodiments of the present disclosure is shown. As shown at block 402, the method 400 includes receiving an input of a prompt template, a part of a table, and an identification of a type of a data processing task to be performed on the part of the table. Next, as shown at block 404, the method 400 includes creating a prompt based on the prompt template and the data from the table. The prompt is then provided to a PLM encoder to obtain a set of prompt embeddings and a set of token embeddings, as shown at block 406. At block 408, the prompt embeddings are then input into a trained neural network to obtain a prefix vector. In exemplary embodiments, the trained neural network corresponds to the type of the data processing task. At block 410, the prefix vector is prepended to the set of token embeddings to create a set of extended embeddings. Next, at block 412, the set of extended embeddings are input into a PLM decoder to obtain an output 414, which is a solution to the data processing task.

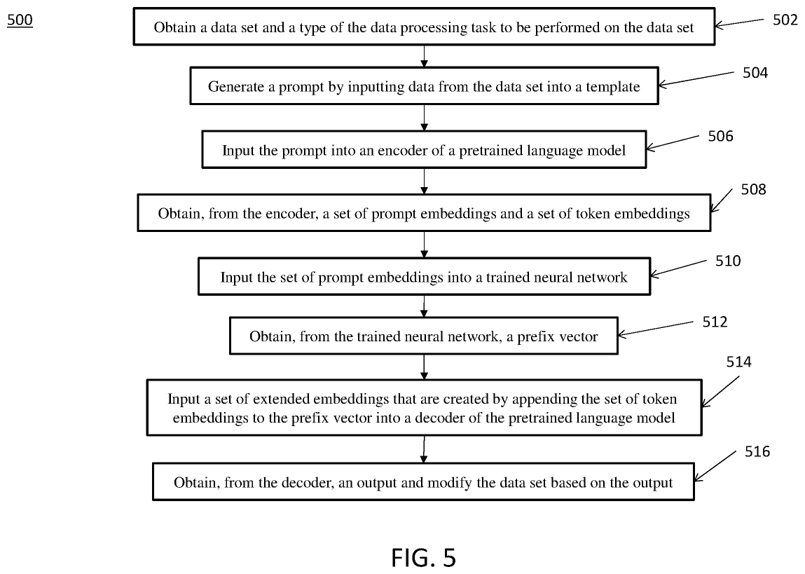

Referring now to FIG. 5, a flowchart of a method 500 for performing a data processing task on a data set with a pretrained language model in accordance with one or more embodiments of the present disclosure is shown. In exemplary embodiments, the method 500 is performed by a system 200 such as the one shown in FIG. 2. As shown at block 502, the method 500 includes obtaining the data set and a type of the data processing task to be performed on the data set. In exemplary embodiments, the type of data processing task to be performed on the data set includes one of entity matching, missing value imputation, error detection, and normalization. Next, as shown at block 504, the method 500 includes generating a prompt by inputting data from the data set into a template. In exemplary embodiments, the template is determined based on the type of the data processing task.

As shown at block 506, the method 500 includes inputting the prompt into an encoder of a pretrained language model. Next, a set of prompt embeddings and a set of token embeddings is obtained from the encoder, as shown at block 508. In exemplary embodiments, the set of prompt embeddings is a feature vector created by the encoder based on the prompt. In one embodiment, the feature vector is a seven-hundred and sixty-eight dimension vector. In exemplary embodiments, the feature vector has a dimension that is equal to a dimension of a token embedding of the pretrained language model. At block 510, the method 500 includes inputting the set of prompt embeddings into a trained neural network. In exemplary embodiments, the trained neural network corresponds to the type of data processing task to be performed on the data set. The trained neural network is created based on a set of training data that corresponds to the type of data processing task to be performed on the data set.

As shown at block 512, the method 500 includes obtaining, from the trained neural network, a set of extended embeddings. Next, as shown at block 514, the method 500 includes inputting a set of extended embeddings that are created by appending the set of token embeddings to the prefix vector into a decoder of the pretrained language model. The method 500 concludes at block 516 by obtaining, from the decoder, an output and modifying the data set based on the output.

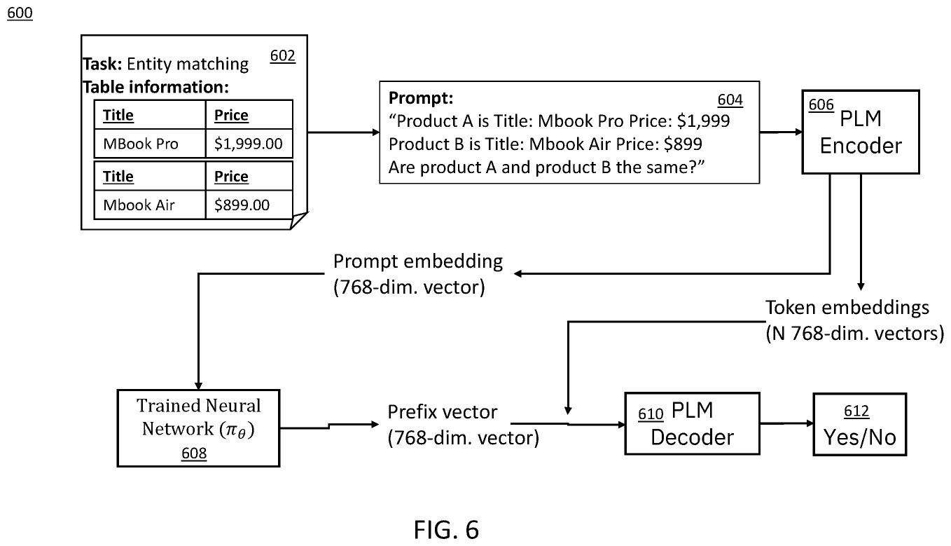

Referring now to FIG. 6, a flowchart of a method 600 for performing a data processing task on a data set with a pretrained language model in accordance with one or more embodiments of the present disclosure is shown. As illustrated, an input 602 is provided that includes table information and a data processing task identifier. Next, based on the input 602, a prompt 604 is created. The prompt 604 has a format that is determined based on the data processing task identifier and that includes data from the table information. The prompt 604 is provided to a PLM encoder 606, which responsively provides a feature vector to a trained neural network 608. The trained neural network 608 generates a prefix vector that is combined with a set of token embeddings that is output from the PLM encoder. The combination of the prefix vector that is combined with a set of token embeddings is referred to herein as a set of extended embeddings. The set of extended embeddings is then provided to a PLM decoder 610 to generate an output 612.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for performing a data processing task on a data set with a pretrained language model, the method comprising:
obtaining the data set and a type of the data processing task to be performed on the data set;
generating a prompt by inputting data from the data set into a template, wherein the template is determined based on the type of the data processing task;
inputting the prompt into an encoder of a pretrained language model;
obtaining, from the encoder, a set of prompt embeddings and a set of token embeddings;
inputting the set of prompt embeddings into a trained neural network;
obtaining, from the trained neural network, a prefix vector;
inputting a set of extended embeddings that are created by appending the set of token embeddings to the prefix vector into a decoder of the pretrained language model;
obtaining, from the decoder, an output; and
modifying the data set based on the output.

2. The method of claim 1, wherein the trained neural network corresponds to the type of the data processing task to be performed on the data set.

3. The method of claim 2, wherein the trained neural network is created based on a set of training data that corresponds to the type of the data processing task to be performed on the data set.

4. The method of claim 1, wherein the type of the data processing task to be performed on the data set includes one of entity matching, missing value imputation, error detection, and normalization.

5. The method of claim 1, wherein the set of prompt embeddings is a feature vector created by the encoder based on the prompt.

6. The method of claim 5, wherein the feature vector has a dimension that is equal to a dimension of a token embedding of the pretrained language model.

7. The method of claim 1, further comprising identifying data from the data set to be input into the template by a data pre-processing module.

8. A computing system having a memory having computer readable instructions and one or more processors for executing the computer readable instructions, the computer readable instructions controlling the one or more processors to perform operations comprising:
obtaining the data set and a type of the data processing task to be performed on the data set;
generating a prompt by inputting data from the data set into a template, wherein the template is determined based on the type of the data processing task;
inputting the prompt into an encoder of a pretrained language model;
obtaining, from the encoder, a set of prompt embeddings and a set of token embeddings;
inputting the set of prompt embeddings into a trained neural network;
obtaining, from the trained neural network, a prefix vector;
inputting a set of extended embeddings that are created by appending the set of token embeddings to the prefix vector into a decoder of the pretrained language model;
obtaining, from the decoder, an output; and
modifying the data set based on the output.

9. The computing system of claim 8, wherein the trained neural network corresponds to the type of the data processing task to be performed on the data set.

10. The computing system of claim 9, wherein the trained neural network is created based on a set of training data that corresponds to the type of the data processing task to be performed on the data set.

11. The computing system of claim 8, wherein the type of the data processing task to be performed on the data set includes one of entity matching, missing value imputation, error detection, and normalization.

12. The computing system of claim 8, wherein the set of prompt embeddings is a feature vector created by the encoder based on the prompt.

13. The computing system of claim 12, wherein the feature vector has a dimension that is equal to a dimension of a token embedding of the pretrained language model.

14. The computing system of claim 8, wherein the operations further comprise identifying data from the data set to be input into the template by a data pre-processing module.

15. A computer program product comprising a computer readable storage medium having program instructions embodied therewith, the program instructions executable by a processor to cause the processor to perform operations comprising:
obtaining the data set and a type of the data processing task to be performed on the data set;
generating a prompt by inputting data from the data set into a template, wherein the template is determined based on the type of the data processing task;
inputting the prompt into an encoder of a pretrained language model;
obtaining, from the encoder, a set of prompt embeddings and a set of token embeddings;
inputting the set of prompt embeddings into a trained neural network;
obtaining, from the trained neural network, a prefix vector;
inputting a set of extended embeddings that are created by appending the set of token embeddings to the prefix vector into a decoder of the pretrained language model;
obtaining, from the decoder, an output; and
modifying the data set based on the output.

16. The computer program product of claim 15, wherein the trained neural network corresponds to the type of the data processing task to be performed on the data set.

17. The computer program product of claim 16, wherein the trained neural network is created based on a set of training data that corresponds to the type of the data processing task to be performed on the data set.

18. The computer program product of claim 15, wherein the type of the data processing task to be performed on the data set includes one of entity matching, missing value imputation, error detection, and normalization.

19. The computer program product of claim 15, wherein the set of prompt embeddings is a feature vector created by the encoder based on the prompt.

20. The computer program product of claim 15, wherein the operations further comprise identifying data from the data set to be input into the template by a data pre-processing module.
